(19) United States
(12) Patent Application Publication
(10) Pub. No.: US 2010/0191603 A1
(43) Pub. Date: Jul. 29, 2010

(54) TRANSACTION STATION WITH ENHANCED USER INTERFACE

(76) Inventor: Nathaniel Christopher Herwig, Lawrenceville, GA (US)

Correspondence Address: PAUL W. MARTIN, NCR CORPORATION, LAW DEPT., 3097 Satellite Blvd., 2nd Floor, Duluth, GA, 30096, US

(21) Appl. No.: 12/359,460

(22) Filed: Jan. 26, 2009

(51) Int. Cl. G06Q 30/00; G06F 3/041; G06F 3/033

(52) U.S. Cl. 705/14.65; 186/59; 705/16; 345/173; 715/863

(57) ABSTRACT

A transaction station with an enhanced user interface. The transaction station includes a housing, a plurality of peripherals in the housing, a touch screen extending substantially across the housing including a display for displaying information and a touch overlay for recording operator selections, and a processor for executing transaction software, wherein the transaction software causes the display to display the information and receives the operator selections from the touch overlay during a transaction.

### BACKGROUND

Current kiosks and self-service systems generally use some form of flat-panel display with a touch screen overlay. Liquid crystal displays (LCDs) are the current technology of choice due to their size, cost, and other factors. This single panel provides the majority of the user interface. Additional user interface elements are sometimes provided on adjacent devices such as credit card readers and PIN pads.

Display technology is advancing rapidly in the area of flexible bi-stable displays. These products are capable of high-quality images on flexible materials or substrates, and generally will “remember” the most recent image when power is removed for months or even years.

It would be desirable to provide a transaction station with an enhanced user interface.

### SUMMARY

A transaction station with an enhanced user interface is provided.

An example transaction station includes a housing, a plurality of peripherals in the housing, a touch screen extending substantially across the housing including a display for displaying information and a touch overlay for recording operator selections, and a processor for executing transaction software, wherein the transaction software causes the display to display the information and receives the operator selections from the touch overlay during a transaction.

Example types of displays may include bistable, cholosteric, liquid crystal, and organic LED (OLED) displays.

### BRIEF DESCRIPTION OF THE DRAWINGS

FIG. 1 is a block diagram of an example transaction station.

FIG. 2 illustrates a first example embodiment of the transaction station.

FIGS. 3a-j illustrate a first example sequence of displayed information by the first example embodiment.

FIGS. 4a-j illustrate a second example embodiment with a second example sequence of displayed information.

### DETAILED DESCRIPTION

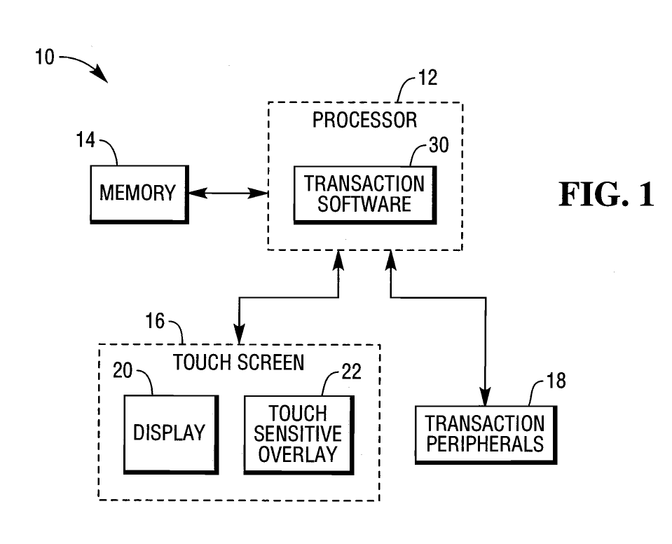

Referring now to FIG. 1, transaction station 10 includes processor 12, memory 14, touch screen 16, and a number of transaction peripherals 18 arranged in one or more cabinets or housings.

Processor 12 executes transaction software 30. Transaction software 30 displays transaction options and instructions, records operator inputs, and controls operation of transaction peripherals 18.

Memory 14 stores transaction software 30 and data used by transaction software 30.

Touch screen 16 includes a display 20 and a touch sensitive overlay 22. Display 20 may include a bi-stable display, cholosteric display, liquid crystal display, organic LED (OLED) display, or any other type of display capable of use with touch overlay 22.

Displayed information may include text, graphics, or a combination thereof. For example, the information may include arrows or other graphic symbols for directing operators to use peripherals.

Touch screen 16 may display many different types of information. For example, touch screen 16 may display active transaction instructions and options, information and instructions related to the transaction such as running balance, coupon and loyalty information (reminder to scan loyalty card), and completely unrelated information such as ads for other products and services, including products and services in the same store (e.g., pharmacy, photo lab, and deli).

In some embodiments, display 20 may display messages in a plurality of colors.

Transaction station 10 may include a self-service or assisted-service transaction station in various forms, such as a kiosk, a terminal, an automated teller machine, a point-of-sale checkout station, or a self-service checkout station. Consequently, transaction peripherals 18 include whatever peripherals are necessary considering the purpose of transaction station 10.

An example kiosk may include a card reader and a printer. An example automated teller machine may include a currency receptacle and dispenser, a card reader, a personal identification number (PIN) keypad, and a printer. An example point-of-sale checkout station may include a code reader, such as a barcode or radio frequency identification label tag reader, a scale, a card reader, a PIN keypad, a coin dispenser, an electronic article surveillance (EAS) tag deactivator, a cash drawer, and a printer.

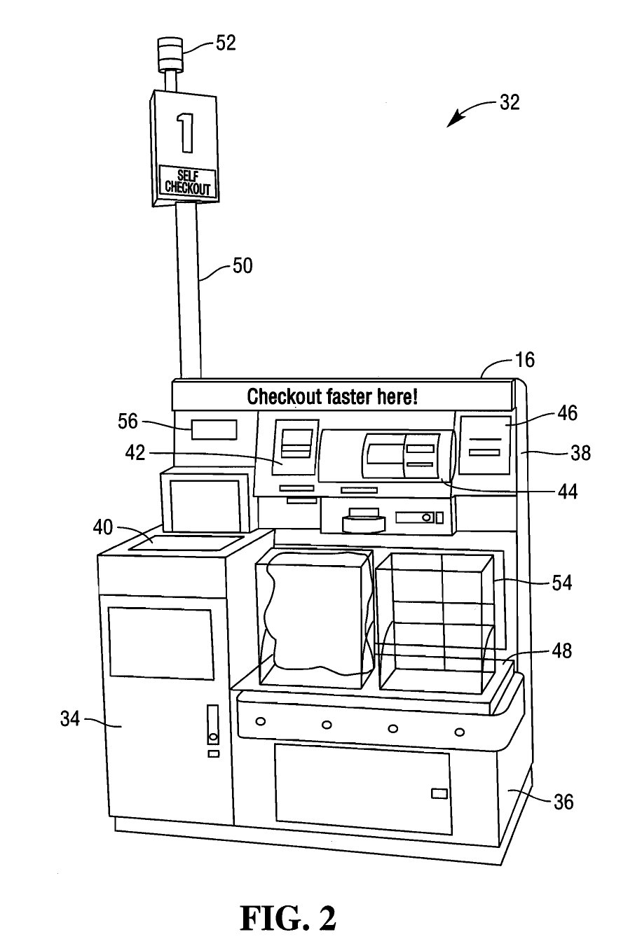

With reference to FIG. 2, an example embodiment of transaction station 10. In this example, transaction station 10 is a self-service checkout station 32. Self-service checkout station 32 may be one of a group of self-service transaction stations 32. An attendant station may monitor the group of self-service transaction stations 32.

Self-service checkout station 32 includes housing sections 34-38 which support mounting of touch screen 16 and peripherals 18.

Self-service checkout station 32 includes a dual-aperture barcode scanner with scale 40, a card reader 42, a cash (currency and/or coin) dispenser/acceptor 44, a receipt printer 46, one or more security scales 48, and a light post 50 with signaling light 52.

Self-service checkout station 32 may be configured with more or fewer peripherals 18. For example, self-service checkout station 32 may include a radio frequency identification tag reader, a signature capture pad, check reader, or other peripheral as dictated by the retailer where self-service checkout station 32 is located.

Touch screen 16 is mounted to housing section 38, in a position above scanner 40, card reader 42, cash dispenser/acceptor 44, and receipt printer 46. Touch screen 16 spans substantially the entire width of housing section 38.

Touch screen 16 displays instructions and prompts in an active portion 24. Active portion 24 includes information involved in completing a transaction. Active portion 24 may vary in size and gradually shift horizontally as the transaction progresses, so that the displayed information is positioned roughly adjacent to and above the related peripherals.

In a remaining passive portion 26, touch screen 16 displays advertisements, information about products, promotions, eye-catching graphics inviting shoppers to use the system (commonly called “attract screens),” or possibly nothing. Passive portion 26 includes information that is not necessarily involved in completing a transaction. However, passive portion 26 may display information related to products involved in a transaction. Passive portion 26 may include touch sensitive areas that a customer may select if the customer wishes further information.

Card reader 42, cash dispenser/acceptor 44, and receipt printer 46 are also located within housing section 38. Barcode scanner 40 is mounted within housing section 34. Security scale 48 is mounted within section 36 under bag racks 54.

When a customer approaches self-service checkout station 32, touch screen 16 may display an initial message, such as “Checkout faster here”, alternating with “Touch screen to begin”. Active portion 24 may be centered. One or more passive portions 26 may occupy the rest of touch screen 16.

As a customer proceeds through a transaction, transaction software 30 causes touch screen 16 to display transaction related information and prompts, and records selections necessary to complete the transaction.

For example, following each step in a transaction requiring a customer to act, transaction software 30 may cause touch screen 16 to display a message, graphic, or other prompt requesting a selection from the customer or directing the customer to an appropriate peripheral 18.

Transaction software 30 may also generate voice messages supporting or echoing messages or prompts displayed by touch screen 16 through one or more speakers 56.

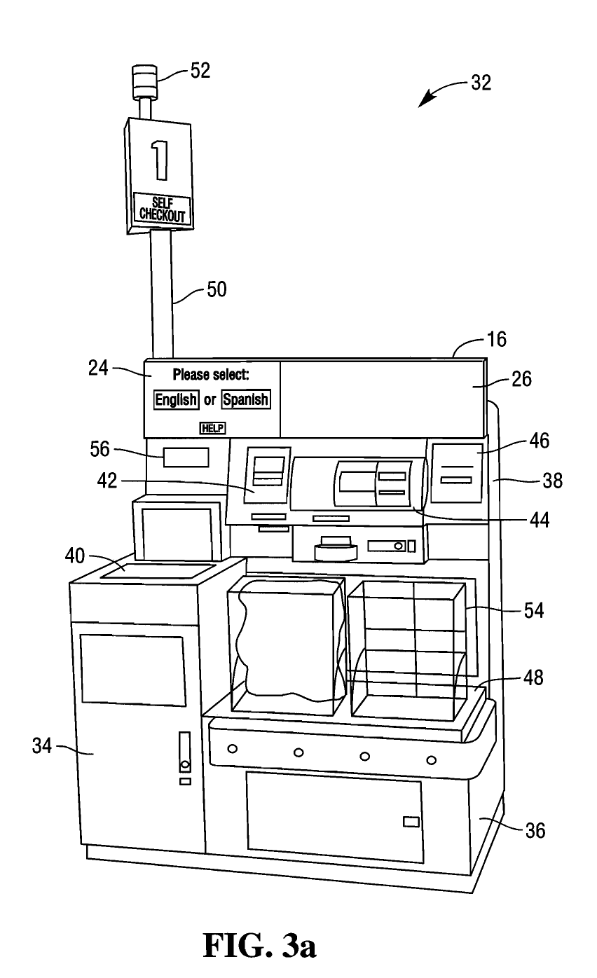

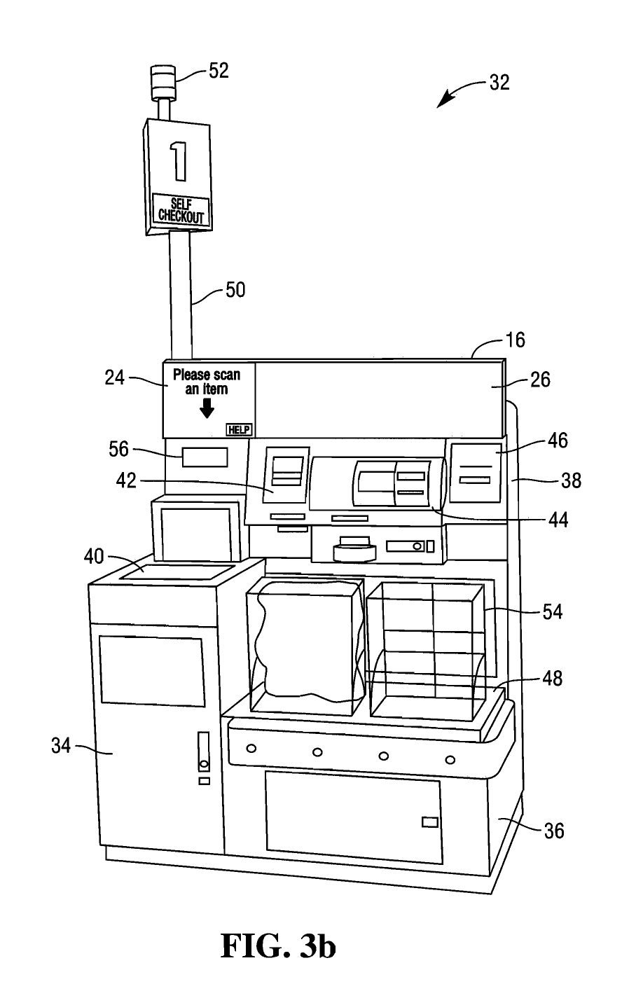

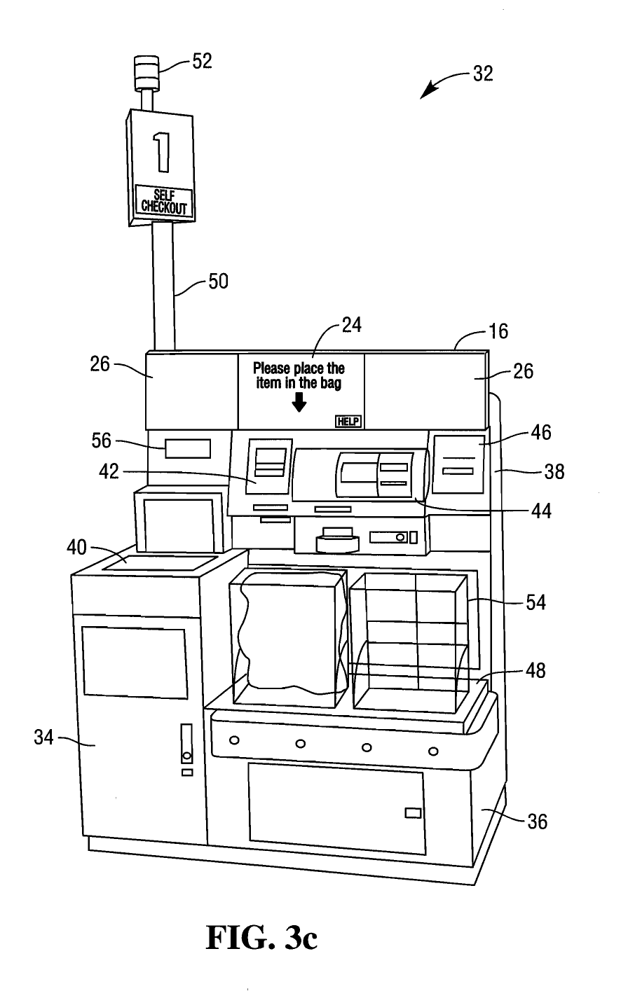

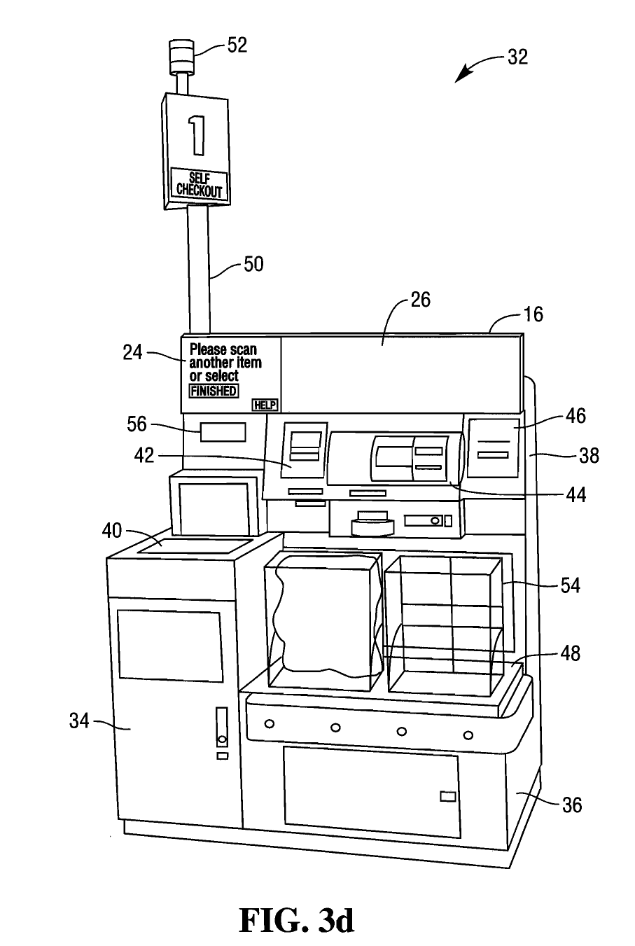

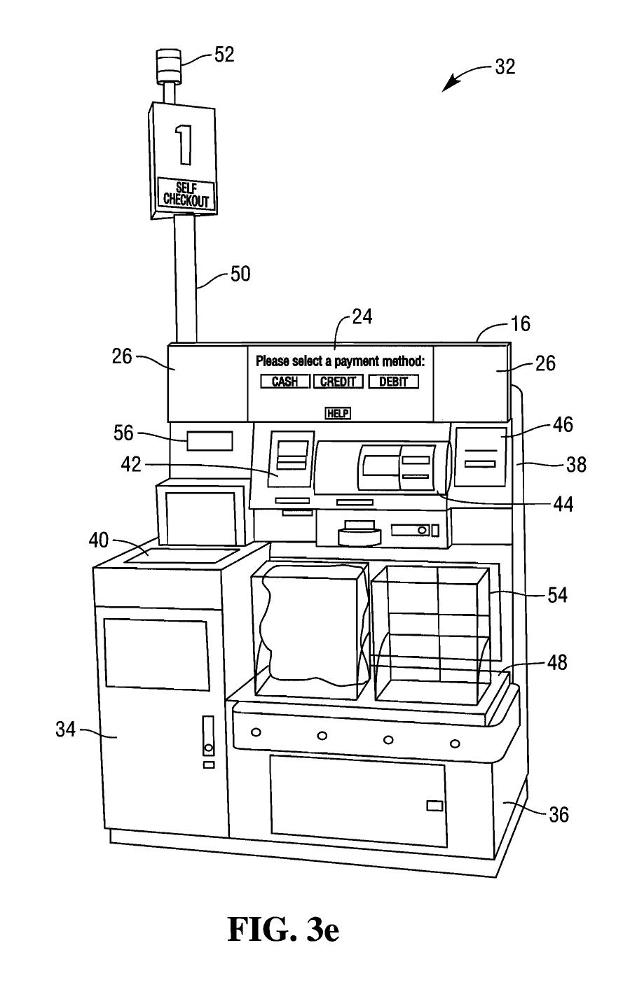

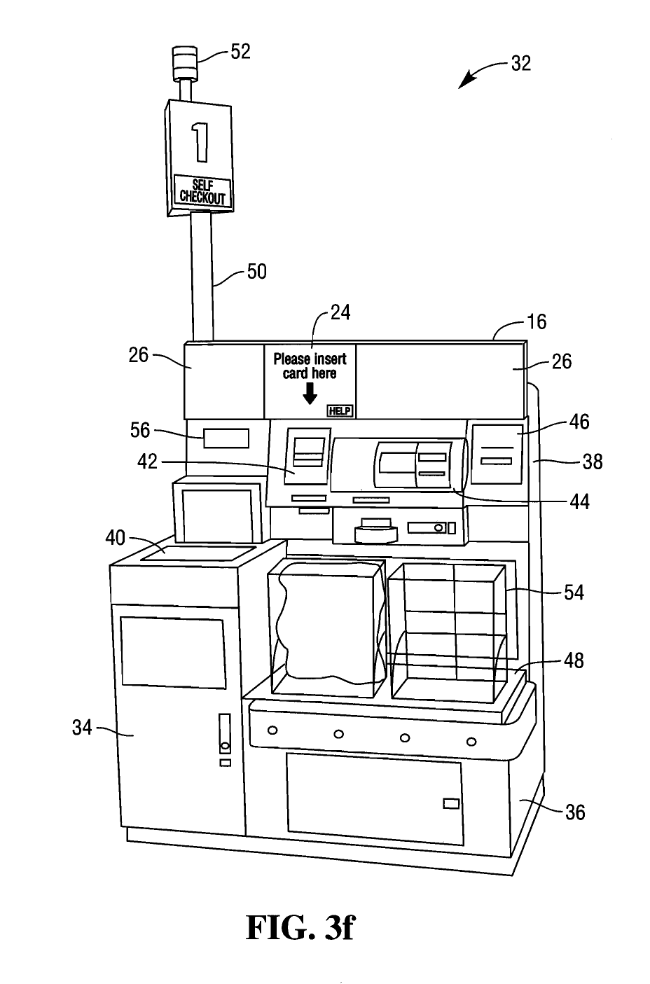

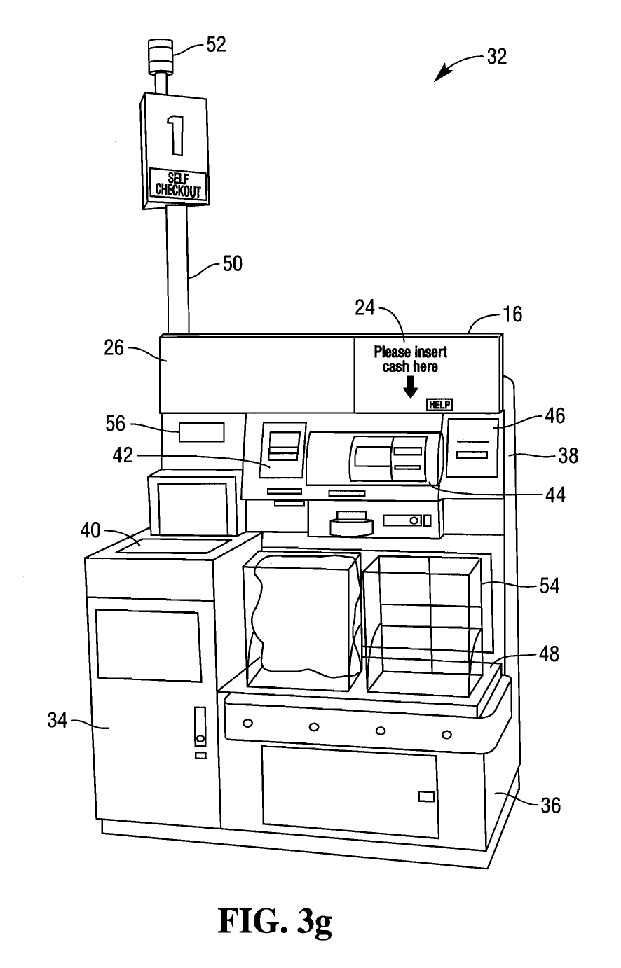

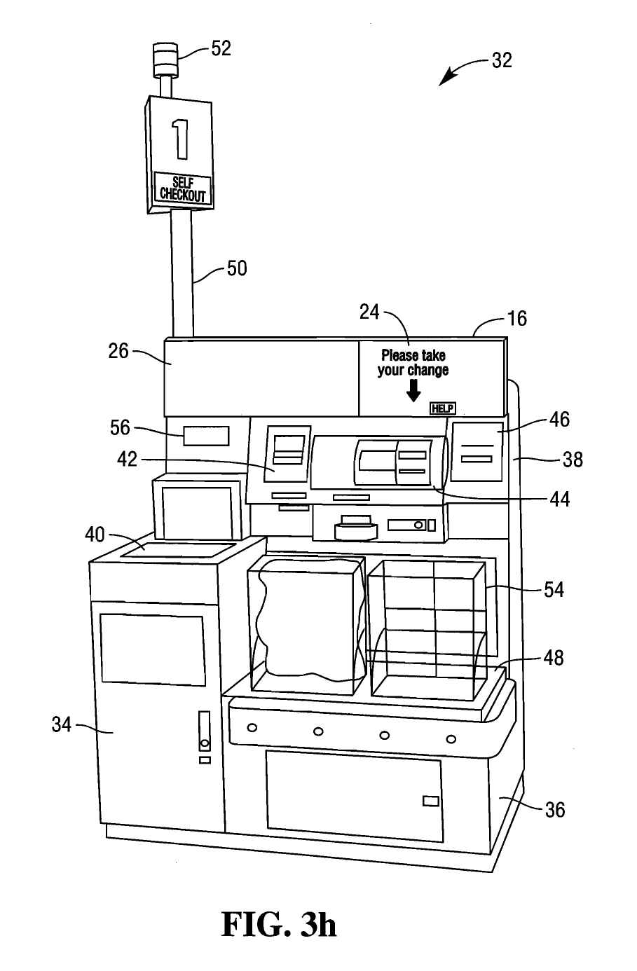

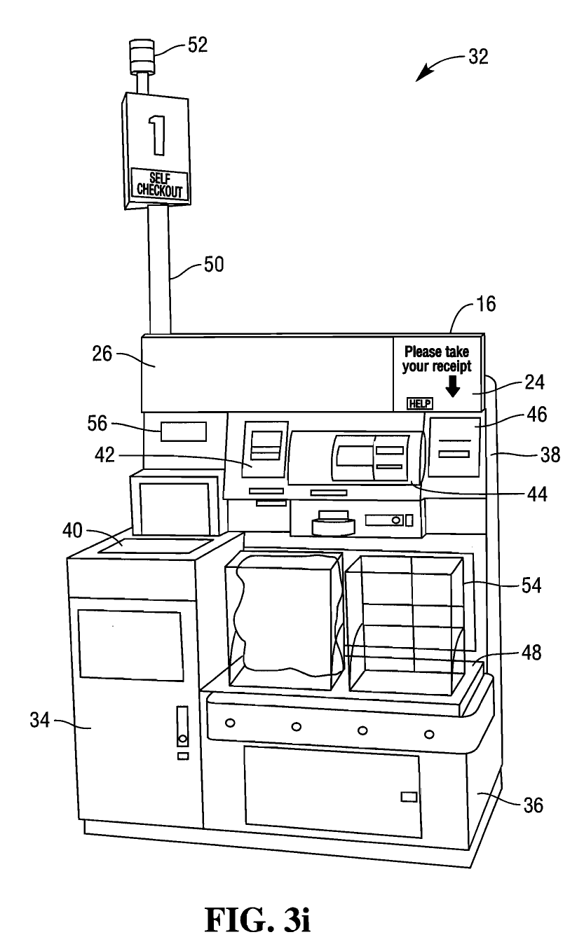

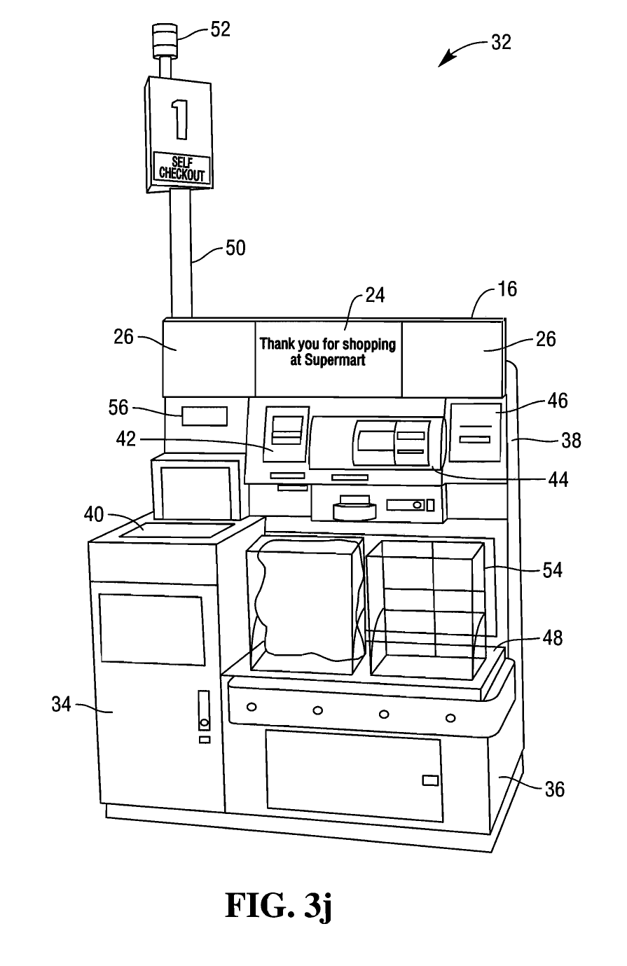

An example sequence of displayed messages that follows a transaction flow is illustrated in FIGS. 3a-j.

In FIG. 3a, transaction software 30 displays a message requesting the customer to select a language preference, for example, English or Spanish, “Please select: English or Spanish”, with the words “English” and “Spanish” emphasized in some way to indicate where the customer should touch to complete a selection.

Transaction software 30 may additionally display one or more help messages associated with selection areas for requesting help. Selecting “Help” may signal transaction software 30 to display a help message, activate indicator 62, or activate a help indicator at the attendant station.

Since the transaction begins with scanner 40, active portion 24 is located on the left side of touch screen 16 adjacent to the scanner peripheral. One or more passive portions 26 may occupy the rest of touch screen 16.

In FIG. 3b, transaction software 30 proceeds as if the language preference were English and displays a message requesting the customer to scan an item, for example, “Please scan an item”, with an arrow pointing to scanner 40. Active portion 24 remains over scanner 40. One or more passive portions 26 may occupy the rest of touch screen 16.

In FIG. 3c, transaction software 30 displays a message in response to receiving a good scan signal from scanner 40 requesting the customer to place the item in a bag, for example, “Please place the item in a bag”, with an arrow pointing to bag racks 54. Active portion 24 may remain over scanner 40 or shift right. Transaction software 30 may cause touch screen 16 to display an arrow pointing towards bag racks 54. One or more passive portions 26 may occupy the rest of touch screen 16.

Transaction software 30 may additional process weight information from security scales 48 to verify that the item was placed in the bag and display additional messages if a security check indicates that the item was not placed in the bag or an item was placed in the bag prior to receipt of a good scan signal.

In FIG. 3d, transaction software 30 displays a message requesting the customer to scan another item or proceed to payment, for example, “Please scan another item or select: Finished”, with the word “Finished” emphasized in some way to indicate where the customer should touch to complete a selection. Active portion 24 may remain over scanner 40. One or more passive portions 26 may occupy the rest of touch screen 16. In addition to messages which are not directly related to the transaction (e.g. advertisements for unrelated products), the passive portion of the display could also display a list of scanned items (e.g. “scrolling receipt”), along with a running total of the transaction, and other useful information such as reminders to scan loyalty cards, loyalty account balances, and similar information.

In FIG. 3e, transaction software 30 displays a message in response to receiving a “Finished” selection requesting the customer to select a payment method, for example, “Please select a payment method: Cash Credit Debit”, with the words “Cash”, “Credit”, and “Debit” emphasized in some way to indicate where the customer should touch to complete a selection. Active portion 24 may shift to a location over the payment peripherals. One or more passive portions 26 may occupy the rest of touch screen 16.

In FIG. 3f, transaction software 30 displays a message in response to a credit or debit card selection requesting that the customer insert a card, for example, “Please insert card here”. Active portion 24 may remain over the payment peripherals. Transaction software 30 may cause touch screen 16 to display an arrow pointing towards card reader 42. One or more passive portions 26 may occupy the rest of touch screen 16.

In FIG. 3g, transaction software 30 displays a message in response to a cash selection requesting that the customer insert cash, for example, “Please insert cash here”. Active portion 24 may remain over the payment peripherals. Transaction software 30 may cause touch screen 16 to display an arrow pointing towards cash dispenser/acceptor 44. One or more passive portions 26 may occupy the rest of touch screen 16.

In FIG. 3h, transaction software 30 displays a message following receipt of a total cash received signal from cash dispenser/acceptor 44 if change is due, for example, “Please take your change”. Active portion 24 may remain over the payment peripherals. Transaction software 30 may cause touch screen 16 to display an arrow pointing towards cash dispenser/acceptor 44. One or more passive portions 26 may occupy the rest of touch screen 16.

In FIG. 3i, transaction software 30 causes printer 46 to print a receipt after payment is completed and displays a message instructing the customer to take the receipt, for example, “Please take your receipt”. Active portion 24 may shift right to a location over printer 46. Transaction software 30 may cause touch screen 16 to display an arrow pointing towards printer 46. One or more passive portions 26 may occupy the rest of touch screen 16.

In FIG. 3j, transaction software 30 displays a final message after printing the receipt to indicate an end to the transaction, for example, “Thank you for shopping at Super Mart”. Active portion 24 may shift towards a centered position. One or more passive portions 26 may occupy the rest of touch screen 16.

Transaction software 30 may display additional messages and prompts related to any additional transaction steps.

In accordance with the second example embodiment, touch screen 16 displays single lines of information at a time in still or moving form. For example, touch screen 16 may display a scrolling or blinking line of information.

As an alternative to a conventional computer display with an aspect ratio of 4:3, 16:9, 16:10, or 15:9, touch screen 16 may have a much higher aspect ratio for displaying single lines of text and/or graphics. Touch screen 16 may span the entire width of housing section 38.

A kiosk may have an aspect ratio as low as about 3:1. A shorter version of self-service checkout station 32 may have an aspect ratio of about 6:1. Still longer versions may include aspect ratios higher than 11:1.

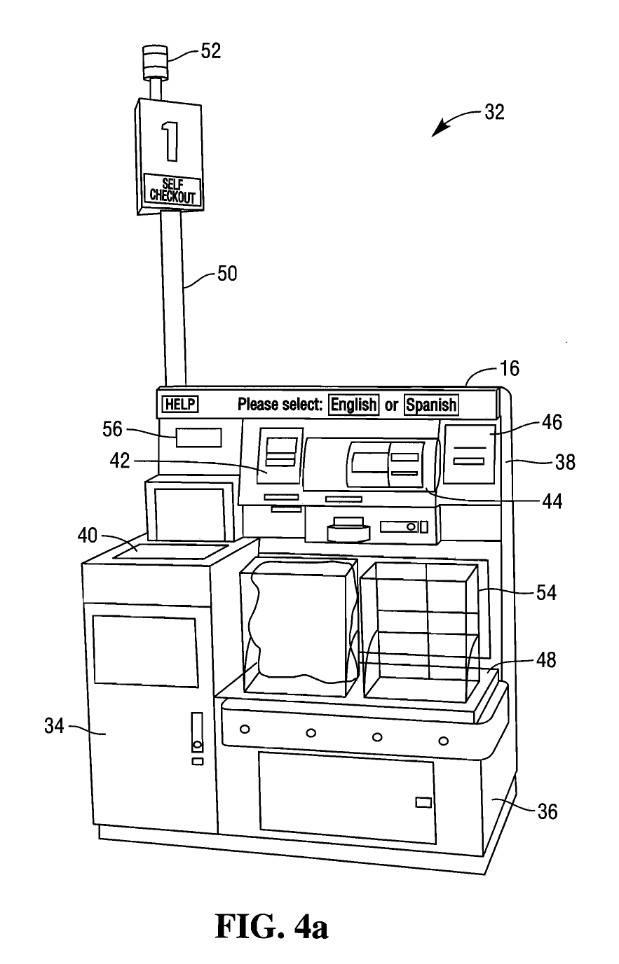

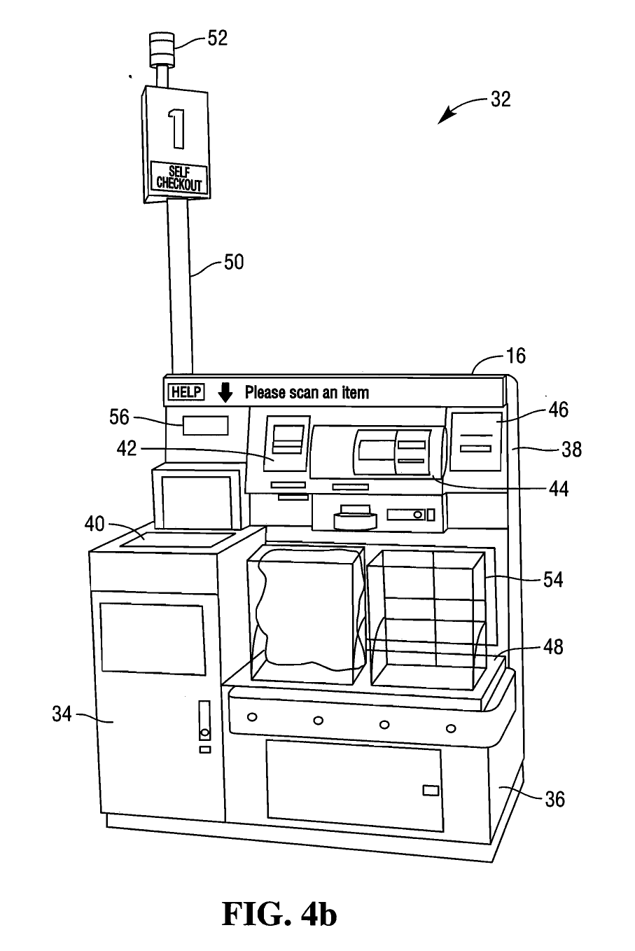

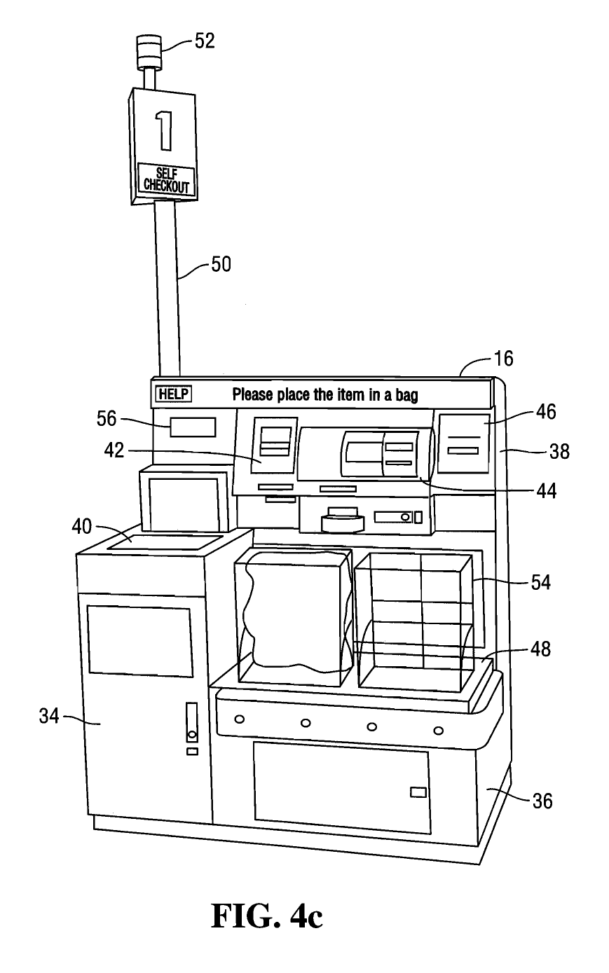

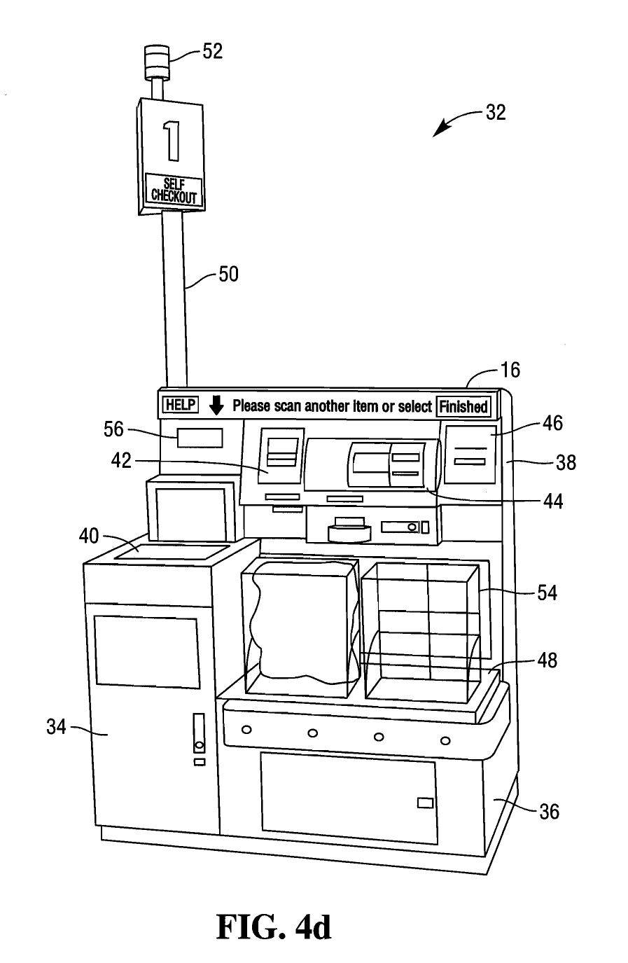

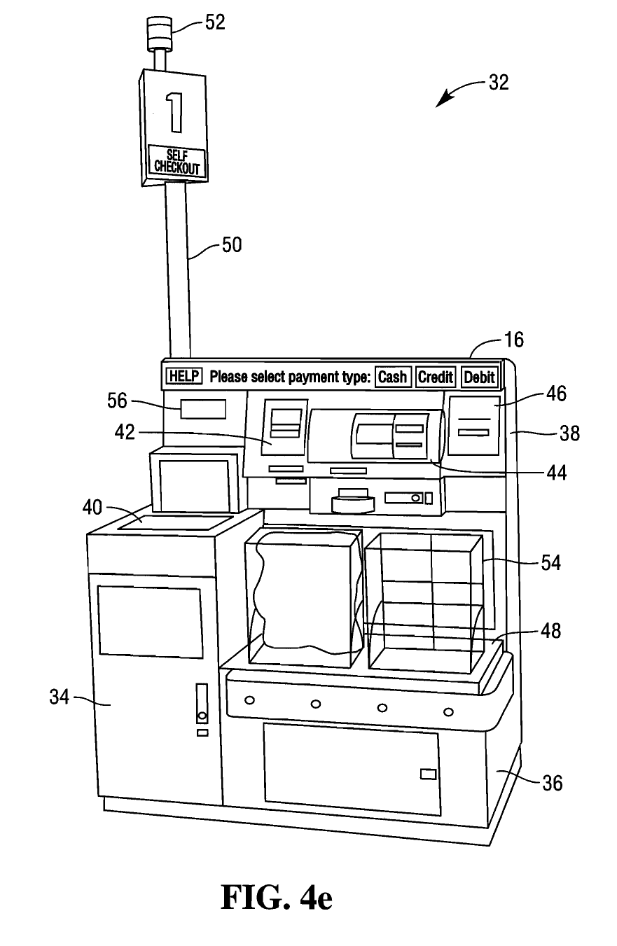

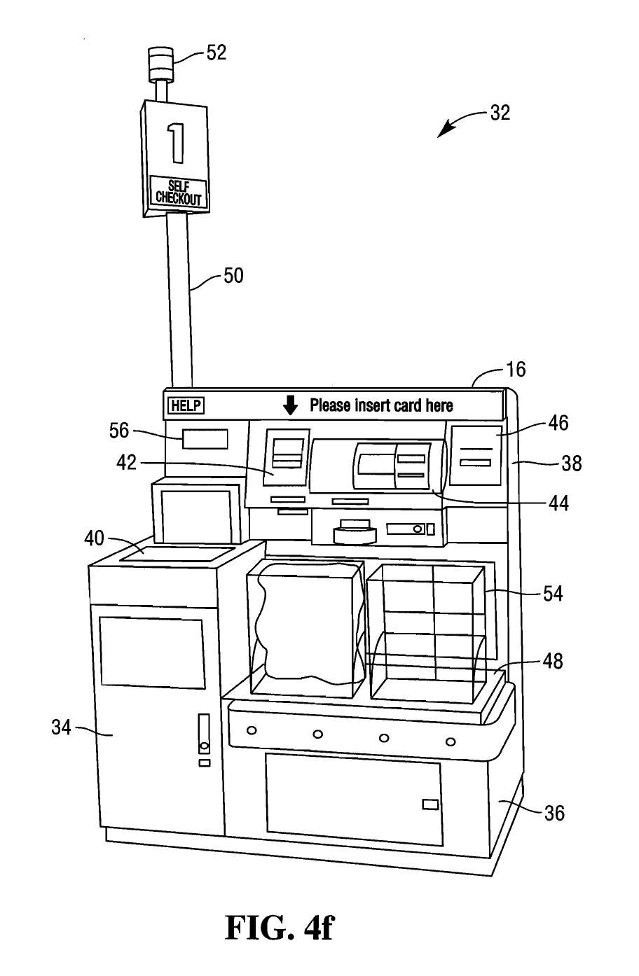

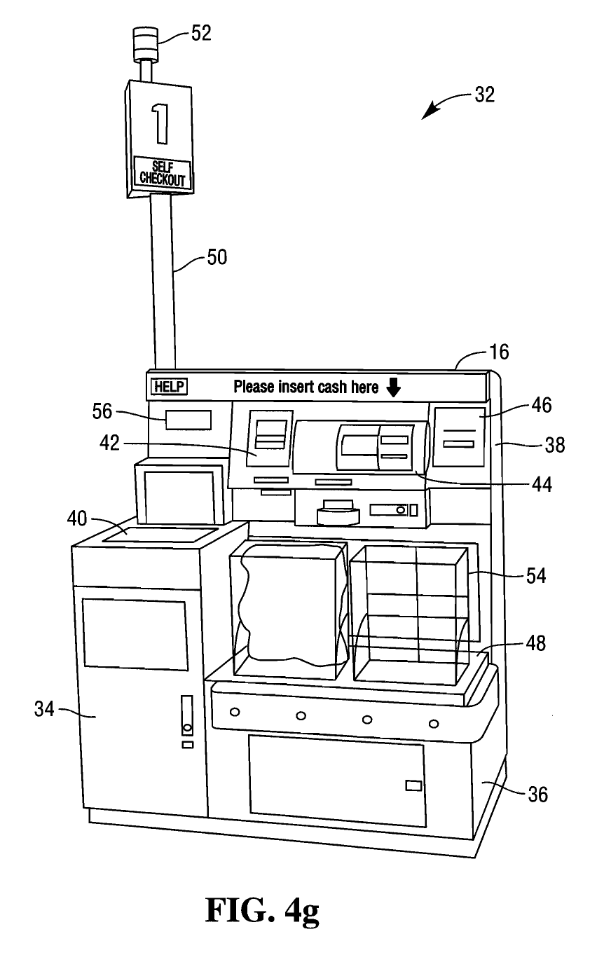

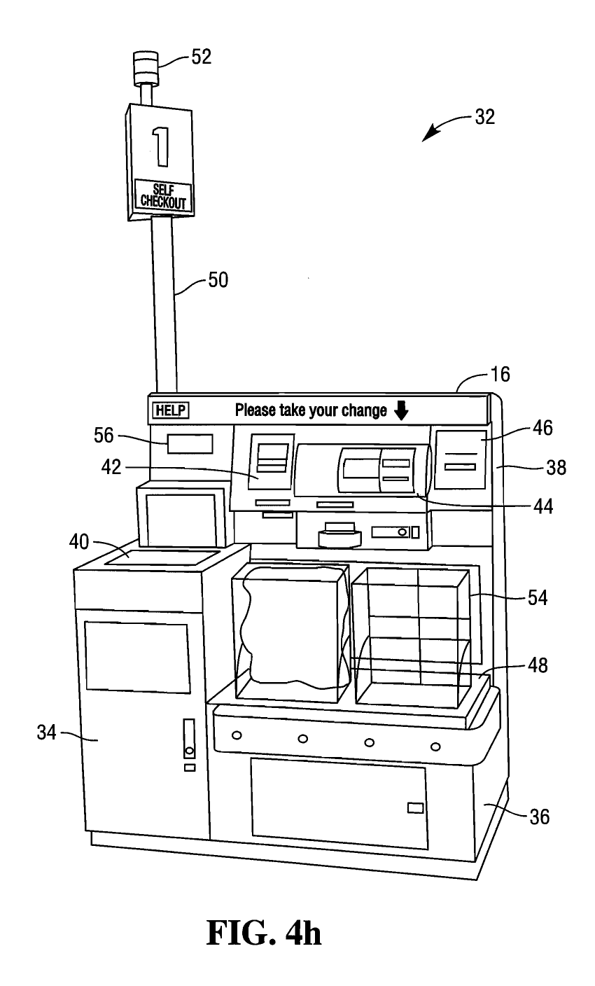

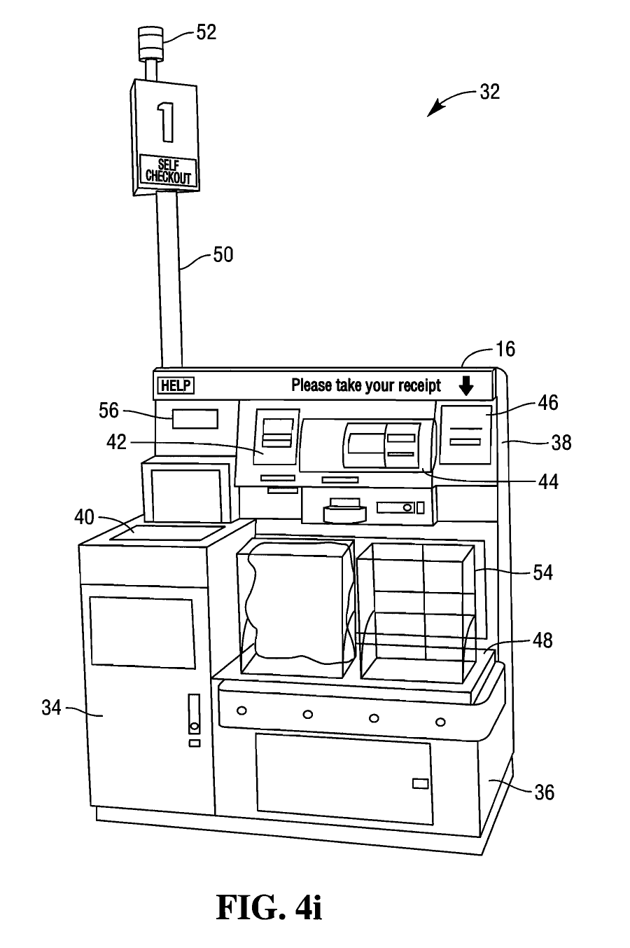

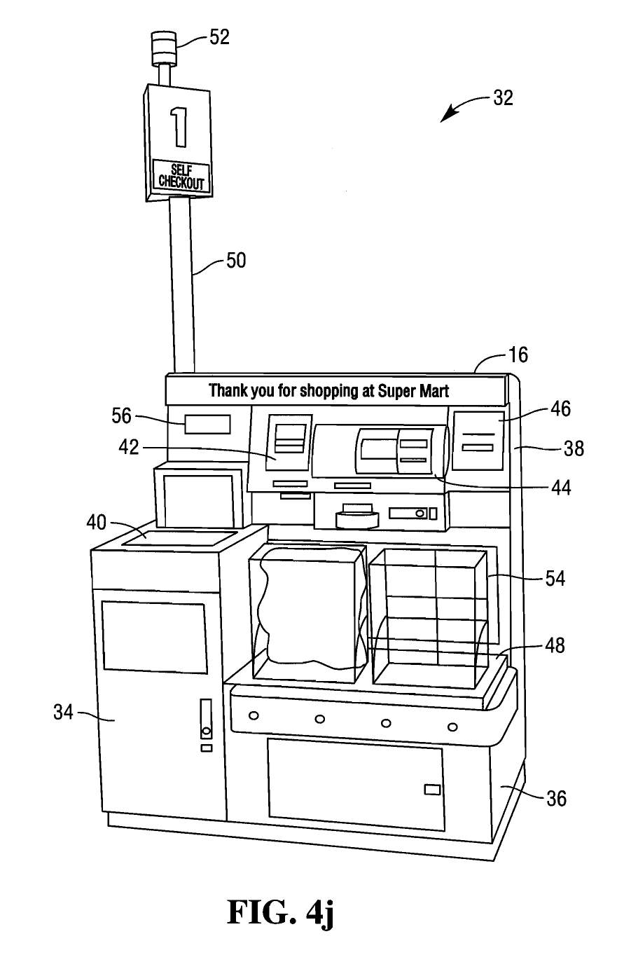

An example sequence of displayed messages that follows a transaction flow is illustrated in FIGS. 4a-j.

In FIG. 4a, transaction software 30 displays a message requesting the customer to select a language preference, for example, English or Spanish, “Please select: English or Spanish”, with the words “English” and “Spanish” emphasized in some way to indicate where the customer should touch to complete a selection.

Transaction software 30 may additionally display one or more help messages associated with selection areas for requesting help. Selecting “Help” may signal transaction software 30 to display a help message, activate indicator 62, or activate a help indicator at the attendant station.

In FIG. 4b, transaction software 30 proceeds as if the language preference were English and displays a message requesting the customer to scan an item, for example, “Please scan an item”, with an arrow pointing to scanner 40.

In FIG. 4c, transaction software 30 displays a message in response to receiving a good scan signal from scanner 40 requesting the customer to place the item in a bag, for example, “Please place the item in a bag”, with an arrow pointing to bag racks 54.

Transaction software 30 may additional process weight information from security scales 48 to verify that the item was placed in the bag and display additional messages if a security check indicates that the item was not placed in the bag or an item was placed in the bag prior to receipt of a good scan signal.

In FIG. 4d, transaction software 30 displays a message requesting the customer to scan another item or proceed to payment, for example, “Please scan another item or select: Finished”, with the word “Finished” emphasized in some way to indicate where the customer should touch to complete a selection.

In FIG. 4e, transaction software 30 displays a message in response to receiving a “Finished” selection requesting the customer to select a payment method, for example, “Please select a payment method: Cash Credit Debit”, with the words “Cash”, “Credit”, and “Debit” emphasized in some way to indicate where the customer should touch to complete a selection.

In FIG. 4f, transaction software 30 displays a message in response to a credit or debit card selection requesting that the customer insert a card, for example, “Please insert card here”, with an arrow pointing to card reader 42.

In FIG. 4g, transaction software 30 displays a message in response to a cash selection requesting that the customer insert cash, for example, “Please insert cash here”, with an arrow pointing to cash dispenser/acceptor 44.

In FIG. 4h, transaction software 30 displays a message following receipt of a total cash received signal from cash dispenser/acceptor 44 if change is due, for example, “Please take your change”, with an arrow pointing to cash dispenser/acceptor 44.

In FIG. 4i, transaction software 30 causes printer 46 to print a receipt after payment is completed and displays a message instructing the customer to take the receipt, for example, “Please take your receipt”, with an arrow pointing to printer 46.

In FIG. 4j, transaction software 30 displays a final message after printing the receipt to indicate an end to the transaction, for example, “Thank you for shopping at Super Mart”.

Transaction software 30 may display additional messages and prompts related to any additional transaction steps.

Although particular reference has been made to certain embodiments, variations and modifications are also envisioned within the spirit and scope of the following claims.

1. A transaction station comprising:
a housing;
a plurality of peripherals in the housing;
a touch screen extending substantially across the housing including a display for displaying information and a touch overlay for recording operator selections; and
a processor for executing transaction software, wherein the transaction software causes the display to display the information and receives the operator selections from the touch overlay during a transaction.

2. The transaction station of claim 1, wherein the information comprises first information involved in completing the transaction and second information not involved in completing the transaction, and wherein the processor displays the first information and the second information in different areas of the touch screen.

3. The transaction station of claim 2, wherein the processor displays the first information in proximity to one or more peripherals involved in a current stage of the transaction.

4. The transaction station of claim 3, wherein the processor displays a message directing customer attention to the one or more peripherals.

5. The transaction station of claim 4, wherein the processor displays a graphic directing customer attention to the one or more peripherals.

6. The transaction station of claim 2, wherein the first information comprises transaction instructions, transaction options, and transaction information, and wherein the second information comprises advertisements.

7. The transaction station of claim 6, wherein the advertisements are related to products and services offered for sale in a store in which the transaction station is located.

8. The transaction station of claim 1, wherein the touch screen has an aspect ratio greater than that of a conventional computer display and the information comprises a single-line message.

9. The transaction station of claim 1, wherein the display comprises a bistable display.

10. The transaction station of claim 1, wherein the display comprises a cholosteric display.

11. The transaction station of claim 1, wherein the display comprises a liquid crystal display.

12. The transaction station of claim 1, wherein the display comprises an organic LED (OLED) display.

13. The transaction station of claim 1, wherein the transaction software is for completing a self-service transaction.

14. The transaction station of claim 1, wherein the transaction software is for completing an assisted-service transaction.

15. The transaction station of claim 1, wherein the information includes text and graphics.

16. A method of completing a transaction comprising:
establishing first and second areas of a touch screen by a processor of a transaction station , wherein the processor displays information involved in completing a transaction in the first areas and information not involved in completing the transaction in the second areas; and
varying the locations of the first and second areas during the transaction by the processor including locating the first areas adjacent to peripherals involved the transaction to direct consumer attention to the peripherals by the processor.

17. A method of completing a transaction comprising:
establishing first, second, and areas of a touch screen by a processor of a transaction station, wherein the processor displays first information including active transaction instructions and options in the first areas, displays second information including other information and instructions related to the transaction in the second areas, and displays third information including advertisements in the third areas; and
varying the locations of the first, second, and third areas during the transaction by the processor including locating the first areas adjacent to peripherals involved in the transaction to direct consumer attention to the peripherals by the processor.
